(19) United States
(12) Patent Application Publication
(10) Pub. No.: US 2020/0250474 A1
(43) Pub. Date: Aug. 6, 2020

(54) SYSTEM FOR ESTIMATING VALUE OF COMPANY USING FINANCIAL TECHNOLOGY

(71) Applicant: UNLISTED LTD, Edinburgh (GB)

(72) Inventors: Daniel Broby, Glasgow (GB); Amandeep Sahota, Smethwick (GB); Bingyao Zhang, Glasgow (GB)

(73) Assignee: UNLISTED LTD, Edinburgh (GB)

(21) Appl. No.: 16/263,582

(22) Filed: Jan. 31, 2019

(51) Int. Cl. G06K 9/62; G06N 3/04; G06Q 30/02; G06F 16/33

(52) U.S. Cl. CPC G06K 9/6256; G06F 16/33; G06Q 30/0278; G06N 3/04

(57) ABSTRACT

There is presented a system for estimating a market value of a private company. The system includes a processor, a query system, a database and a memory. The processor is configured to run a machine learning algorithm for computing a valuation coefficient. The query system is adapted to retrieve financial data of the private company from a first data source; and to retrieve training data for training the machine learning algorithm from a second data source. The database is configured to store the financial data and the training data. The memory stores instructions to cause the processor to train the machine learning algorithm using the training data, to compute the valuation coefficient; and to compute a valuation of the private company based on the financial data and the valuation coefficient.

### TECHNICAL FIELD

The present disclosure relates to a system and method for estimating the market value of a company. In particular, the present disclosure relates to a system and method for estimating the market value of a privately held company in real time.

### BACKGROUND

A publicly traded company has an observable stock price and a market value. This is not the case for a private company, which typically has no real time stock price. As a result, the valuation of private companies can be a difficult and often highly subjective procedure. Valuation algorithms such as, multiple-based and discounted cash flow models (DCF), may be used to give a view of fair value of a company and to determine investment decisions that lead to price discovery. The market value of a publicly listed company theoretically takes into account all publicly available information. This is not the case for unlisted shares in private companies. The estimated value of a private company may depend on whether the valuation is performed from the buyer or from the seller perspective. Common problems lie in finding a valuation multiple and finding a truly comparable public listed company for a private company that is being valued to be benchmarked against. A number of approaches have been proposed in the finance literature as reported in U.S. Pat. No. 8,468,081B2. These techniques usually involve finding a comparable company based on some pre-determined quantitative and qualitative criteria.

A body of literature suggests that existing valuation multiples do not yield precise valuations. The existing method still provides a basis for comparison and is widely used by investment bankers and appraisers in valuing private companies (Demirakos et al., What valuation models do analyst use? Accounting Horizons, Vol. 18, No. 4, (2004): 221-240). Previous studies, for example by Kaplan and Ruback (The market pricing of cash flow forecasts: Discounted cash flow vs. the method of “comparables”.” Journal of applied corporate finance 8, no. 4 (1996): 45-60) compared valuations derived from the DCF method and the method of multiples and found that DCF approach yielded the most reliable estimates overall and using multiples resulted in the lowest valuation errors. However, many studies such as Liu, Nissim and Thomas (Equity valuation using multiples, Journal of Accounting Research, 40, No. 1, (2002): 135-172) find valuation errors of around 28%. It is clear there is a need for a valuation technique that achieves higher accuracy in valuation of private companies.

### SUMMARY

According to a first aspect of the disclosure, there is provided a computer-implemented method for estimating a market value of a private company, the method comprising the steps of: retrieving financial data of the private company from a first data source; providing a machine learning algorithm configured to deliver a valuation coefficient; retrieving training data for training the machine learning algorithm from a second data source; training the machine learning algorithm; computing the valuation coefficient using the trained machine learning algorithm; and computing a valuation of the private company based on the financial data and the valuation coefficient.

Optionally, the method comprises identifying a plurality of public companies having similar characteristics as the private company; and retrieving data associated with the public companies to obtain the training data.

Optionally, identifying the plurality of public companies comprises identifying companies operating in a same industry.

Optionally, the method comprises comparing characteristics of the private company with characteristics of public companies and selecting companies having similar characteristic to the private companies.

Optionally, the characteristics comprise risk, growth rate, capital structure, number of employees, cash flow and liquidity data.

Optionally, the valuation coefficient is an enterprise multiple.

Optionally, the training data include a plurality of data set, each set comprising input data and output data.

Optionally, the machine learning algorithm comprises a set of parameters, and wherein training the machine learning algorithm comprises adjusting the parameters of the machine learning algorithm to reduce an error.

Optionally, wherein the machine learning algorithm comprises a neural network algorithm comprising a set of weights and bias. For example the neural network includes an input layer, an output layer and at least one hidden layer.

Optionally, training the machine learning algorithm comprises applying at least one of a multi-layer perceptron algorithm and a support vector machine algorithm to the training data.

Optionally, the method comprises using the multiple layer perceptron algorithm to obtain a first error and the support vector machine algorithm to obtain a second error; and comparing the first error with the second error.

According to a second aspect of the disclosure there is provided a system for estimating a market value of a private company, the system comprising: a processor configured to run a machine learning algorithm for computing a valuation coefficient; a query system adapted to retrieve financial data of the private company from a first data source; and to retrieve training data for training the machine learning algorithm from a second data source; a database configured to store the financial data and the training data; and a memory storing instructions to cause the processor to train the machine learning algorithm using the training data, to compute the valuation coefficient; and to compute a valuation of the private company based on the financial data and the valuation coefficient.

For instance, the system may be implemented as a server or a plurality of servers.

Optionally, the query system is adapted to identify a plurality of public companies having similar characteristics as the private company and to retrieve data associated with the public companies to obtain the training data.

Optionally, the query system is adapted to group the training data according to a type of companies.

Optionally, the processor is adapted to run a plurality of machine learning algorithm, each machine learning algorithm being associated with a particular type of companies.

Optionally, the database is configured to store the training data in different groups each group being associated with a type of companies.

Optionally, the system comprises a module adapted to perform textual analysis to retrieve data from a document.

Optionally, the query system comprises at least one of i) a filter configured to filter data stored in the first data source; and ii) an identifier configured to identify specific data stored in the second data source. For example the filter may be adapted to filter companies according to a number of employee. The identifier may be adapted to identify companies operating in a particular industry.

Optionally, the database comprises a first storage portion configured to store static data and a second storage portion configured to store dynamic data; and wherein the processor is adapted to retrieve static data and dynamic data using a data link.

The static data may be retrieved and stored in the database with a first rate having a first frequency and the dynamic data may be retrieved and stored using a second rate having a second frequency greater than the first frequency.

The system according to the second aspect of the disclosure may comprise any of the options described above in relation to the first aspect of the disclosure.

According to a third aspect of the disclosure, there is provided a computer-readable data carrier having stored thereon instructions which when executed by a computer causes the computer to carry out the steps of the method according to the first aspect of the disclosure.

A computer-readable data carrier or computer readable medium may include both computer storage media and communication media including any medium that facilitates transfer of a computer program from one place to another. A storage medium may be any available medium that can be accessed by a computer.

The third aspect may share features of the first and second aspects, as noted above and herein.

### DESCRIPTION OF THE DRAWINGS

The foregoing aspects and the attendant advantages of the inventive technology will become more readily appreciated as the same become better understood by reference to the following detailed description, when taken in conjunction with the accompanying drawings, wherein:

FIG. 1 is a flow diagram of a method for estimating a market value of a private company;

FIG. 2 is a diagram of a system for implementing the method of FIG. 1;

FIG. 3 is an exemplary embodiment of a system according to FIG. 2;

FIG. 4 is a diagram illustrating machine learning process;

FIG. 5 is a diagram of a system that includes textual analysis;

FIG. 6 is a diagram of an exemplary system for gathering and storing data; and

FIG. 7 is a diagram of an error calculation for training a machine learning algorithm using a support vector machine.

### DETAILED DESCRIPTION

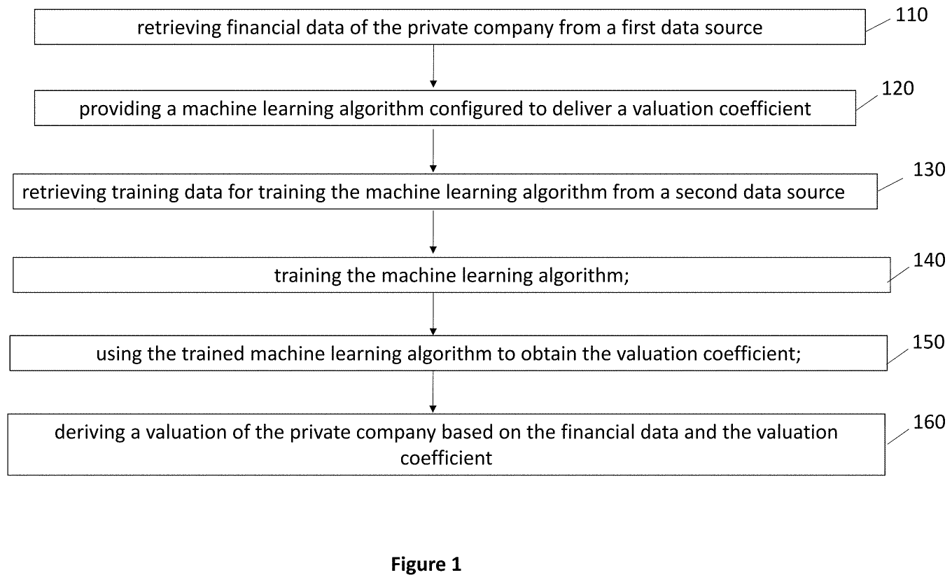

The following disclosure describes private company valuation, and associated systems and methods. A person skilled in the relevant art will also understand that the technology may have additional embodiments, and that the technology may be practiced without several of the details of the embodiments described below with reference to FIGS. 1-7.

FIG. 1 illustrates a method for estimating a market value of a private company.

At step 110 financial data of the private company are retrieved from a first data source. For instance the data source may be a database provided by a regulatory organisation such as Companies House in the UK or the Electronic Data Gathering, Analysis, and Retrieval system EDGAR in the USA.

At step 120 a machine learning algorithm configured to deliver a valuation coefficient is provided. For instance, the machine learning algorithm may be a neural network algorithm. The valuation coefficient may be a multiple such as an enterprise multiple. An enterprise multiple is a ratio, with respect to some accounting data (value driver) for example Earnings Before Interest Taxation, Depreciation and Amortisation (EBITDA), used to determine the value of a company in relation to that particular accounting data and it is expressed as:

$$\begin{matrix}\text{Enterprise} \\ \text{multiple}\end{matrix} = \frac{\text{Enterprise value}}{\begin{matrix}\text{Earning before interest, tax, depreciation and} \\ \text{amortization} ( EBITDA )\end{matrix}} \qquad ( 1 )$$

At step 130 training data for training the machine learning algorithm are retrieved from a second data source. For instance the second data source may be a database provided by a data vendor. The training data may be stock-market data. Training data from listed companies may include share price, total number of shares outstanding, total debt outstanding, industry classification and various other financial and accounting data.

At step 140 the machine learning algorithm such as support vector machine or neural network is trained using the training data. For instance if the machine learning algorithm is a neural network algorithm a Multi-layer perceptron (MLP) may be used to calibrate the neural network algorithm. The training data include input data associated with known output data. By feeding the input data to the neural network, the algorithm provides a certain value that can be compared with the known output value. Therefore an error may be computed by taking the difference between these two values. The algorithm is calibrated by reducing this error over multiple iterations using many different set of training data. Training the machine learning algorithm may be achieved by applying a training algorithm such as a Multi-Layer Perceptron algorithm (MLP) or a Support Vector Machine algorithm (SVM) to the training data.

At step 150 the trained machine learning algorithm is used to obtain the valuation coefficient. The machine learning algorithm provides an adjustable valuation coefficient. So during the training of the machine learning algorithm, the value of the valuation coefficient may vary as various parameters of the algorithm are being adjusted. Once the machine learning has been trained the machine learning algorithm delivers an adjusted valuation coefficient, that is one obtained using a calibrated machine learning algorithm.

At step 160 a valuation of the private company is derived based on the financial data and the valuation coefficient. For instance if the valuation coefficient is an enterprise multiple obtained from the trained machine learning algorithm, the valuation of the private company is derived by the product of EBITDA with the enterprise multiple. Different algorithms may be provided for different types of companies. For instance a companies may be classified by industry, size, or various risk factors.

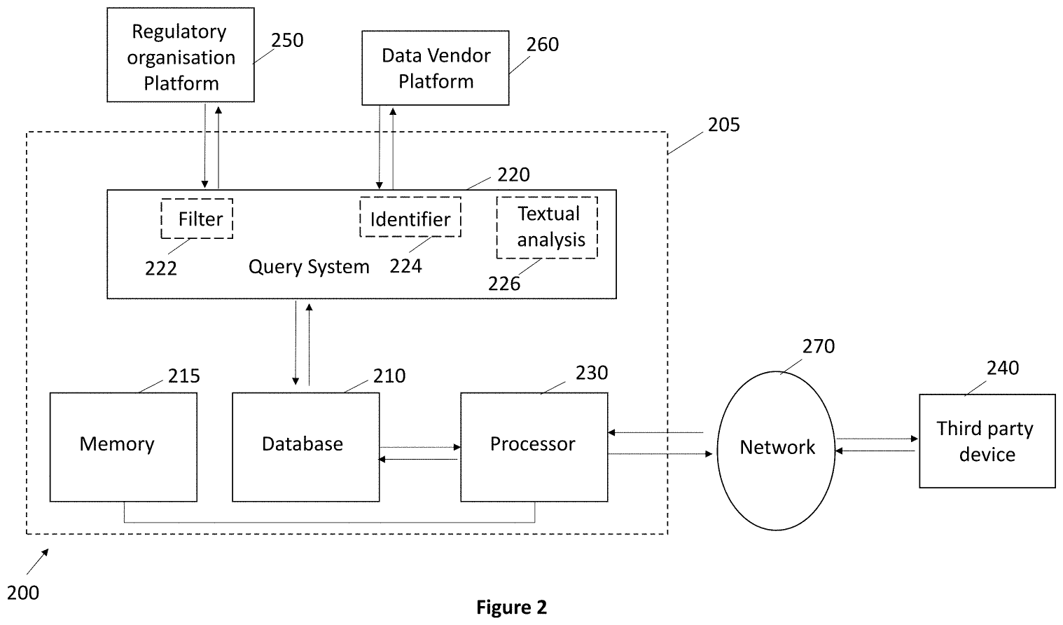

FIG. 2 is a diagram of a system for estimating a market value of a private company according to the method of FIG. 1. The system 205 includes a database 210 coupled to a query system 220 and a processor 230. A memory 215 coupled to the processor 230 is adapted to store various instructions. A third party device 240, such as a personal computer or a mobile phone may communicate with the system 205 via a network 270.

The query system 220 includes three data ports: a first data port for communicating with the database 210, a second data port for communicating with a first data source 250, and a third data port for communicating with a second data source 260. Additional data sources and associated data ports may be provided depending on the application. The query system 220 may be provided with a filter 222 to filter data stored in the first data source 250. The query system 220 may also be provided with an identifier 224 configured to identify specific data stored in the second data source 260. The processor 230 is configured to run a machine learning algorithm for delivering a valuation coefficient. The processor 230 may also be configured to run one or more training algorithms for training the machine learning algorithm.

The first data source 250 may be a regulatory organisation platform storing data regarding various privately held companies. The second data source 260 may be a data vendor platform storing data regarding various public companies.

Optionally, a text recognition module 226, may be provided to extract information relevant to the valuation of a company from one or more unstructured documents. The text recognition module 226 may include a list of key words to look for in the document being analysed. Such a list of key words may include various words relating to how well or how poorly a company may be performing. The text recognition module 226 may be adapted to communicate with a data source that utilizes key financial descriptor words to indicate tone and direction in written financial reports.

The database 210, the query system 220 and the processor 230 may be implemented in different fashions. For instance, the database 210, the query system 220 and the processor 230 may be distributed in two or three different servers. Alternatively, the database 210, the query system 220 and the processor 230 may be included in a single server. Data may be stored and processed in the cloud.

In operation, the query system 220 retrieves financial data regarding one or more private companies of interest from the first data source 250. This may be achieved via the filter 222. For instance the filter 222 may be used to select data associated with a private companies having a minimum size.

The query system 220 also retrieves training data for training the machine learning algorithm from the second data source 260. This may be achieved via the identifier 224. For instance the identifier 224 may be configured to identify public companies having similar characteristics as private companies of interest. This may be achieved by comparing various company characteristics, such as industry type, size or number of employees, and various other accounting considerations. These characteristics may be industry specific. The data retrieved by the query system 220 from the second data source 260 include a set of input data and output data for training the machine learning algorithm.

The financial data and the training data may be extracted from various machine-readable statements including balance sheet, income statements, cash flow statements.

The query system 220 stores both the financial data retrieved from the first data source 250 and the training data retrieved from the second data source 260 into the database 210.

The database 210 may include different storage portions and be configured to store separately data relating to private companies and data relation to public companies. The database 210 may include a first storage portion for storing static data that vary relatively slowly and a second storage portion for storing dynamic data that vary relatively fast. For instance static data may be accounting data such as financial reports. Static data may only need to be retrieved relatively rarely such as once or twice a year. Dynamic data include various financial data that vary regularly or constantly; for instance daily. Example of dynamic data include stock market data. The database 210 may also include other various portions including a portion for storing training data and a portion for storing documents to be analyzed by the textual analysis module 226. Different portions of the database 210 may be linked through a company specific data link also referred to as company key. That is a key that is unique to a particular company and that is trackable over time.

The query system 220 is therefore adapted to gather data from the first data source 250, the second data source 260 and optionally from other data source, and then store the data in a particular portion of the database 210 associated with the nature of the data being retrieved. The processor 230 is adapted to retrieve specific data stored in the database 210 using one or more data links. For instance the processor 230 may retrieve training data stored in a training data portion for performing a training function. The processor may also retrieve private company data of a specific company to calculate the valuation of this company upon request.

The training data may be split into various subset of data. For instance a subset of data may be used for training purpose and a remaining subset may be used to use the trained machine learning algorithm to obtain the valuation coefficient. The processor 230 is configured to derive a valuation of the private company based on the financial data and the valuation coefficient.

For instance, the training data may include sets of inputs and corresponding outputs obtained for selected companies. The inputs may include various financial data of a public company, and the corresponding output may be the valuation coefficient of the company, for instance the enterprise multiple of the company.

By selecting public companies which are similar to the private company of interest, a set of training data can be retrieved to train the machine learning algorithm. Similarity may be determined by a forward or backward feature selection algorithm. In this way a value coefficient such as an enterprise multiple can be estimated for the private company. In turn the processor 230 calculates the value of the company. For instance the processor may calculate EBITDA from the financial data retrieved from the first data source and then calculate the private company value following equation (1).

The valuation of the private company may be stored in the database 210 and subsequently transmitted to the third party device 240. For instance the third party device 240 may send a request to retrieve a valuation of a specific private company. The valuation may then be provided via a website or mobile application through a feed.

The process may be run in real-time to reflect changing market conditions on private company valuations using a live feed from the stock market, financials databases and Companies House/Edgar. The system will recalibrate valuation algorithms in real-time with varying inputs. Various programming languages such as Python, C++, Java, VBA and H5 may be used for intracompany communication between the various components of the system.

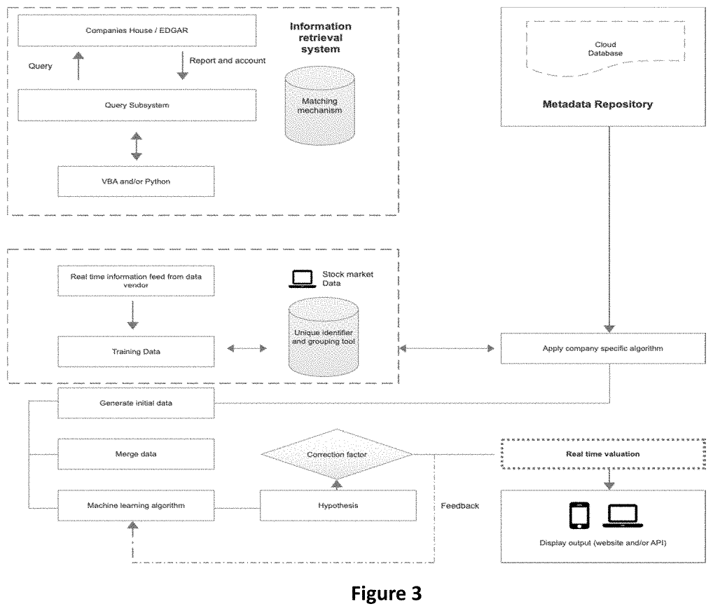

FIG. 3 illustrates an exemplary embodiment of the system of FIG. 2. A neural network and support vector machine to calibrate our valuation algorithms to value private companies is presented. Data is retrieved from stock market, financial databases and regulatory bodies such as EDGAR and Companies House. The captured data is then stored in a metadata repository. Data limitations for private companies restricts what ratios can be calculated. But for publicly listed companies, a range of ratios may be computed including liquidity, profitability, leverage and performance ratios. The ratios have a dual purpose. Firstly, they form part of the input into the machine learning process. Secondly, firms may be matched and clustered into groups based on certain inputs.

The market values of publicly listed companies may be generated as follows. For companies with multiple share classes, values are generated by taking the sum of different share classes and total debt. The market value is given by:

Market value=Total Number of Shares×Price of Share+Total Debt

The common approach to valuing private companies is the discounted cash flow (DCF) and multiple-based methodology. However, there are many unsettled issues with the application of the DCF methodology itself. The reliability of the technique depends on the accuracy of cash flow projections and the use of appropriate risk measures. The less reliable these inputs, the less reliable the resulting valuations.

The approach used in the present disclosure is based on multiples of companies operating in similar industries. By calculating multiples of various relevant financial parameters, such as sales or earnings, the estimated multiples can then be applied to the values of these parameters for the company being valued.

By way of example, suppose the adjusted total capital to EBITDA multiple of comparable publicly listed firms is 5.1 times the previous 12-months sales. Then, if the target company's trailing 12-month EBITDA are £7 million, its estimated value using the 5.1 multiple would be £35.7 million.

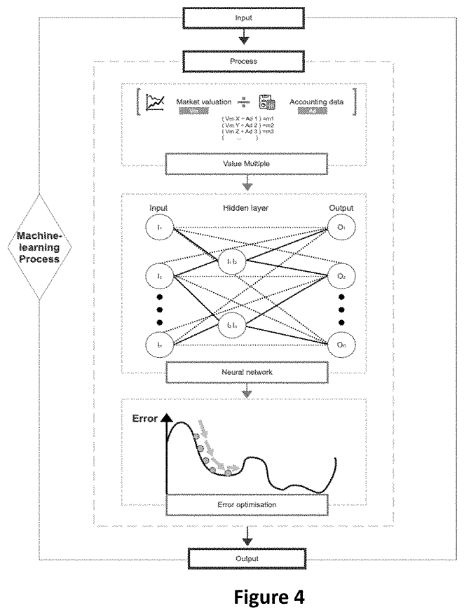

A summary of how the algorithm works is presented in FIG. 4, and then the full Multi-Layer Perceptron (MLP) training algorithm using back-propagation of error is described.

Firstly, a feed of input vectors is input into the nodes of the neural network algorithm. The data is then fed into the valuation algorithm optimization system where initial valuation results are compared with the training data extracted from the stock exchange information systems. The machine optimizes from this data at a learning rate to produce a real-time valuation result that is then disseminated via a web or mobile interface.

Within the network, the valuation algorithms are sent forward and backwards. The weights of the inputs and first-layer (which are labelled below as v) determine whether the hidden nodes are activated. For a given input, a function determines activation, denoted g(·) below, which is a sigmoid function. The outputs of these neurons and the second-layer weights (labelled as w) determine whether the output neurons are activated.

A valuation coefficient is created at each iteration and a valuation error is then computed as the sum-of-squares difference between the estimated valuation (network outputs) and the stock market valuation (targets) of a publicly traded company. The error is then fed backwards through the network, updating the second-layer weights and then the first-layer weights in the process.

The method of matching private company to public companies may involve computing clusters and classes that aim to, firstly, group similar companies by some input factor(s) in each industry and, secondly, assign probabilities to each class that they take up a certain value.

FIG. 4 is a diagram illustrating the machine learning process. In a neural network, the learning mainly happens in the weights assigned to the nodes, with the aim of recalibrating the algorithm. The number of neurons and connections provided in the network may vary. By adding neurons between the input nodes and the outputs, more complex neural networks can be obtained. The network is trained so that the weights are adapted to generate the valuation multiples that minimise valuation error.

Rumelhart, Hinton, and McClelland (A general framework for parallel distributed processing, Parallel distributed processing: Exploration in the microstructure of cognition 1, no. 45-76 (1986): 26) proposed the Multi-Layer Perceptron (MLP) which is commonly used in the machine learning methods. The problem that this technique aims to solve is in the setup of neural network, which is what weights should be updated (i.e. those in the first layer, or the second) or how should the activation function be adjusted for the neurons in the hidden layers.

The Multi-Layer Perceptron is trained in two parts (described in, for example, Machine learning: an algorithmic perspective, second edition, Machine learning and pattern recognition series, Chapman & Hall/CRC, 2015). Given the inputs and weights, what are the outputs, and updating the weights to minimise the error, which is a function of the difference between the outputs and the targets. The activation functions of the hidden layer and output layer can then be determined by the inputs and weights. Since the inputs that caused the error are unknown, the second layer weights cannot be updated. In the machine-learning literature, techniques such as chain rule of differentiation are used to know how the error changes with the weights.

We can then compare them to the targets and compute the error. The process will start again by feeding the error back into the network, technique known as the back-propagation of error. Since the objective is to minimise the valuation error, optimisation techniques such as form of gradient descent attempts to find a global minimum of a function.

The use of this approach in the disclosure is helpful because all of the derivatives required can be computed. The error calculations are sent back through the network to the hidden layer to determine what the target outputs were for those neurons. This is achieved by linking the activations of the output nodes to the activations of the weights of the output nodes and hidden nodes.

Adding more layers to the network is suggested but means it is harder to arrange but the concept remains the same, which is making the error function as small as possible for each neuron k: Error(k)=output(k)−target(k).

There are two errors that can be made here: an over-estimate and an under-estimate of the value of company, i.e. the valuation coefficient is too high or too low. In a situation two errors being the same size, summing them up could get 0, suggesting no error was made. It is common to use sum-of-squares error function, which is the sum of the differences between output and target for each node squared.

Below is an algorithm that could have many hidden layers, and in which case, there can be many hidden nodes, and number of weights between the hidden layers and the outputs.

Our process assumes that there are input nodes, hidden nodes, and output nodes (P, Q and R, respectively), all with a weight, threshold or bias. So, there are (P+1)×Q weights between the input and the hidden layer and (Q+1)×R between the hidden layer and the output.

The bias nodes, which also have adjustable weights, are depicted by the extra +1 s. The errors coming from the training data drive the values of these weights through the back-propagation algorithm.

The sums will start from 0 if they include the bias nodes and 1 otherwise. The letters i, j and m are used to index the nodes in each layer in the sums, along with s, t and u for fixed indices. The letters v and w represent weights of the first- and second-layer nodes and, a and b are activation functions.

To begin, for given input vector x, all weights are initialised to small (positive and negative) random values, and the system is trained by repeating for each input vector.

The multi-layer perception valuation algorithm will now be described.

To initiate, in the Forward phase, the input vectors are fed into the network: hₛ=Σᵢ₌₀^{P}xᵢvᵢₛ; and the activation of each neuron k in the hidden layer(s) is computed by following function

$${a}_{s} = g ( {h}_{s} ) = \frac{1}{1 + {e}^{- β {h}_{s}}} .$$

The hidden and output layers will receive an input hₜ=Σⱼaⱼwⱼₜ; and activated using the following function

$${b}_{t} = g ( {h}_{t} ) = \frac{1}{1 + {e}^{- β {h}_{t}}} .$$

The learning rate of the system will depend on the initial values of its weights and biases, as well as network topology and learning rate. One possibility is setting all the weights to 0 and then assess the learning rate of the network, however, the literature on machine-learning advocates against assigning the same weights as they will have a tendency to assume identical weights during training. The MLP literature suggests that the weights should be initialised to small random numbers, both positive and negative.

In the Backwards phase, the errors will need to be computed at the output stage as follows: θₜ^{o}=(bₜ−tₜ)bₜ(1−bₜ). Similarly, the error in the hidden layer(s) are computed using: θₛ^{h}=aₛ(1−aₛ)Σₘ₌₁ⁿwₛθₒ(m).

The learning in the network happens by minimisation of the network error by gradient descent. The error is sent through the network in order to update the output layer weights using: wₛₜ←wₛₜ−γθₜ^{o}aₛ^{hidden}, and then updating the hidden layer weights using: vᵤ←vᵤ−γθₛ^{o}xₛ, until learning stops.

One method to assign weights is random initialisation. Alternative methods can include weights based on statistical and/or geometrical analysis of data, pseudo-inverse method for perceptron. Using network parameters can be another way of assigning weights. The literature also suggests the weights can be set within the range −1/√n<w<1/√n (where w is the initialisation value of the weights and n is the different inputs/feeds to the neuron).

By adopting the above method, a neuron will have the total input of a maximum size of about 1. Further, large weights will mean that the gradients are small, and so the learning is very slow. In this case, the activation of a neuron is likely to be near 0 or 1. The reasoning goes back to the interplay with the value of beta in the logistic function, but essentially suggests that small values are more effective.

In the algorithm described above, the hidden- and the output layer include sigmoid neurons. For classification problems and, in addition to having classes be 0 and 1, a continuous output can be generated (i.e. not just 0 or 1)

In particular, having output neurons with linear nodes can be useful in regression problems, in cases where a real number is required, not just a 0 or 1. For example, it can take the sum of the inputs and give that as their activation. In such a case, these output neurons will not have activate/do-not-activate characteristics. There are usually no changes to hidden layer neurons.

Soft-max activation function are a third type of frequently used output neuron that can rescale the outputs to lie between 0 and 1. Typically this is achieved by calculating the exponential of the inputs to that neuron and then dividing by the total sum of the inputs to all of the neurons. It is most commonly used for classification problems.

In the optimisation process, the values of the weights are adjusted in order to minimise the error function. A common problem incurred in the optimisation process is that following the slope downhill may lead to a local minimum and there is no guarantee that it is a global minimum.

The likelihood of finding the global minimum may be improved by following: having many different starting points and training many different networks. This can be implemented by adding in some contribution to the current weight from the previous weight change in the network. This momentum makes it possible to use a smaller learning rate, which means that the learning can be more stable.

Weight decay may also be added to the procedure (the size of the weights decreases as the number of iterations increase). The literature suggests that small weights are more effective than larger weights. This is because smaller weights lead to a network that is closer to linear. Only the weights that are essential to the non-linear learning are large.

Reducing the learning rate as the algorithm progresses can improve the convergence and behaviour of the network. This is because we expect the algorithm to make large changes to the weights at the start, when they were initially chosen at random. Large changes in weights in the later stages of the process could indicate a problem.

In the back-propagation algorithm, it is often the case the first and second derivatives are used in the learning process. First derivatives are used to drive the learning and second derivatives can further improve the network. Thus, it is common to include information about the second derivatives of the error with respect to the weights.

The amount of training data has both advantages and disadvantages. On the one hand, more training data can be better for learning, but on the other hand, the time that the algorithm takes to learn can increase. A benefit of using stock-market data, as there is large amount of data on listed companies from the stock market.

The problem at hand dictates what the minimum amount of data that is required. Literature suggests that the training set is at least 10 times the number of weights in the network.

More importantly, it is important to acknowledge number of weights and learning rate can depend on the number of hidden nodes, and the number of hidden layers. For an effective application of the algorithm these choices are critical.

To train the MLP, the algorithm runs multiple times, and the weights are adjusted as the network makes errors in each iteration. When to stop learning can be a critical decision. The learning should not stop using a fixed number of iterations, fixed amount of time or acceptable valuation error.

Once the network has been trained for some predetermined amount of time, the validation sets may be used to estimate how well the network is generalising. The network can then carry on training and the whole process will be repeated. The monitoring of ability of the network to generalise at its current stage of learning provides useful information.

The valuation errors during training typically reduce fairly quickly during the initial training iterations. In certain cases, the error on the validation set may start increasing rather than decreasing further, which may be due to the noise in the data. At this stage, the training should be stopped.

Various output encoding may be chosen—standard neurons, or linear nodes. Usually, input features and targets that are available to solve the problem will determine these. Inputs may be normalised, for example, by dividing by an input vector for example by total assets, taking the natural logarithm or a similar method. Inputs may be added or removed (forward or backward feature selection method) to test what impact it has on the learning rate and whether these inputs have any new information.

The data collected is usually split into three sets: training, testing, and then a third set for validation, which is testing how well the network is learning during training. The amount of data that is available will determine the ratio between the sizes of the three groups. The following ratio may be chosen around 50:25:25. More complex networks require more data for training and take longer to optimise. The method of selecting a network architecture, as described in the literature, is to try several with different numbers of hidden nodes and see which works best.

The training of the neural network includes using the Multi-Layer Perceptron algorithm and applying it to the training data. It may be run in conjunction with early stopping. The generalisation ability of the network is tested, after a few iterations of the algorithm through all of the training data, by using the validation set.

Once the network has been trained, the test valuation data is put to use. This will test how well the network performs on some unseen data that and will determine whether this network can be used for other data, for which there are no targets (i.e. private companies).

There are a number of ways to assess the learning of algorithm with respect to how it improves on a valuation. Firstly, Accuracy is the sum of the number of true positives and true negatives, as extracted from the stock exchange data, divided by the total number of examples.

Secondly, sensitivity and precision are two measurements that help interpret the performance of a classifier. In the machine learning literature, Sensitivity the number of correct positive examples divided by the number classified as positive. Precision number of correct positive examples divided by number of actual positive examples.

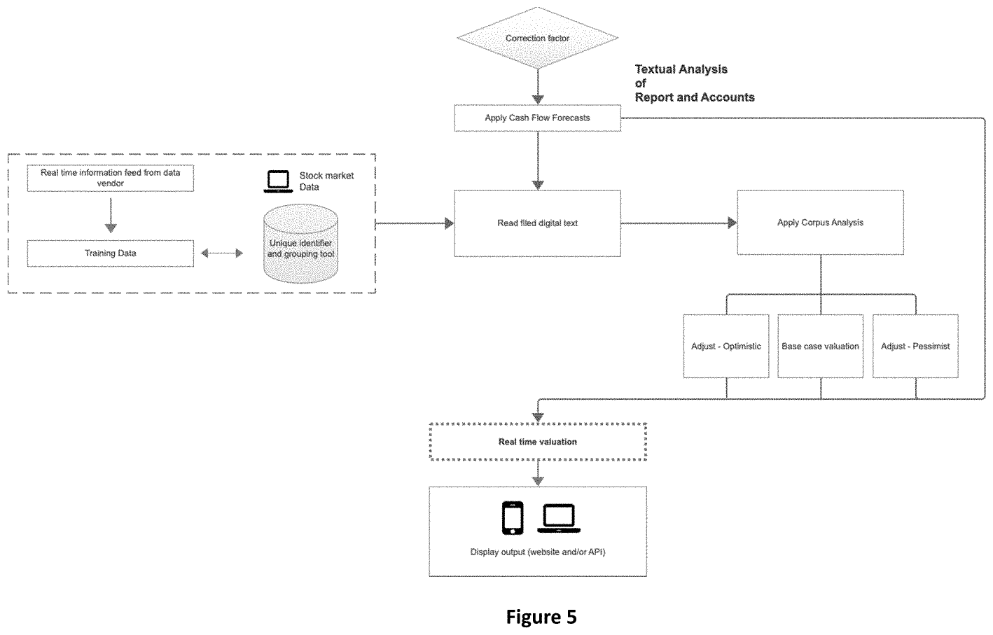

FIG. 5 illustrates a system that includes textual analysis. The system of the disclosure may be provided with a module adapted to perform textual analysis. This permits to assist the forecasting of valuation based on written reports and a custom corpus of words that depict management information. An algorithm may be provided to crawl through a document to identify key words that depict either optimism or pessimism about a company's financial performance. This requires reformatting and processing the financial reports. The original document page numbers and then re-paginated based on the document numbering. Once synchronized the start and end of each section have to be identified. Where sections begin and end on the same page there is a measurement error potential. When the document is a pdf it may be challenging to capture information present in tables and charts. The directional information that the textual analysis brings is then fed into the valuation forecast.

The processing tool may be adapted to separate text from tables. The processing tool may also be adapted to separate narrative and financial statements. Common headings must be assigned in order to allow cross sectional analysis.

The approach may be based on constructing wordlists in order to extract the relevant variables that affect valuations. For instance, the wordlist may include valuation specific words relating to managerial integrity. Essentially, creating a set of words (dictionaries) related to valuation or corporate performance, and how these can be differentiated by context. For example, words like achieve, exceed, optimistic, pessimistic. These can then be applied to the downloaded reports from Edgar or Companies House. Wordlists such as these are available from Diction, General Inquirer, and domain specific word lists like Loughran and McDonald (When is a liability not a liability? Textual analysis, dictionaries and 10-Ks, The journal of finance, 66, no. 1, (2011): 35-65) and Henry (Market reaction to verbal components of earnings press release: Event study using a predictive algorithm, Journal of emerging technologies in accounting, Vol. 3(1), (2006)). Specifically, Athanasakou et al. (Annual report management commentary articulating strategy and business model: Measurement and Impact (2018)) produced a word list for strategy and business models and Li (The information content of forward-looking statements in corporate filings—A naïve Bayesian machine learning approach, Journal of accounting research, 48, no. 5, (2010): 1049-1102) for corporate performance metrics.

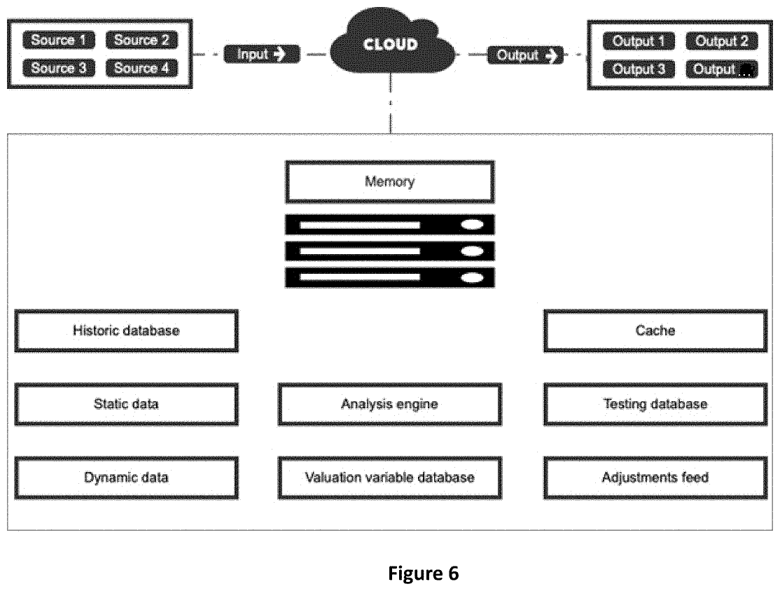

FIG. 6 depicts data input into the cloud which may be from many sources. For instance private company data may be extracted from Companies House or EDGAR. Public company data may be extracted from the stock market. Private company data may also be extracted through an application programming interface (API) directly from a company's computer system. Most recent data are to be stored in a cache memory for immediate retrieval, and previously processed data may be stored in an historic database.

Data may be stored in a Dynamic part or a Static part of the storage depending on the frequency of retrieval. For instance, the data may be separated by public and private company, and further separated into static data and dynamic data. Different sections of the database may be linked through a key which is unique to the firm and that is trackable over time. The static data may refer to accounting data such as financial reports. Dynamic data may refer to financial data such as stock market data.

Data may also be input into the storage through a textual analysis system. The system may be provided with a module adapted to perform textual analysis. In this case an algorithm may be provided to crawl through a document to identify key words that depict for example either optimism or pessimism about a company's financial performance. This requires reformatting and processing of the financial reports stored in the Adjustments feed.

An analysis engine draws from the data stored in the Dynamic part and Static part to cleanse, prepare and sort the data for each company. The inputs for the AI are built in an analysis engine. Data such as valuation multiple are stored in a valuation variable database. The data used during the training is stored in a testing database.

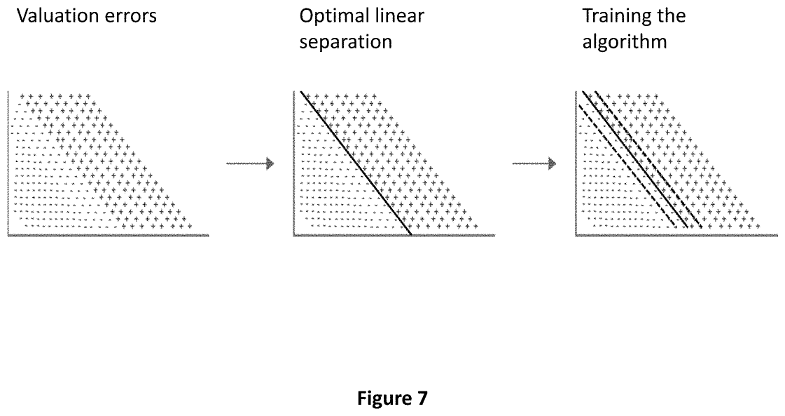

FIG. 7 illustrates an error calculation for training the machine learning algorithm using a support vector machine (SVM). A second layer of machine learning algorithm, embedded in the processor, may be used in combination with the Multi-Layer Perceptron (MLP) training algorithm described above. For instance a Support Vector Machine may be used to train the valuation algorithm and obtain a valuation coefficient. The errors of the machine learning algorithms may be compared in the processor to generate an optimal valuation coefficient.

The training data may be used in the classification of error (either a positive error or a negative error in valuation) to achieve an optimal separation. Once an optimal linear separation is achieved, an optimal line may be identified. The data points that lie within a specified margin may be referred to as support vectors.

A skilled person will appreciate that variations of the disclosed arrangements are possible without departing from the disclosure. Although the method of the disclosure has been illustrated using a neural network, it will be appreciated that other machine learning techniques may be used for instance Random Forest algorithm. Accordingly, the above description of the specific embodiment is made by way of example only and not for the purposes of limitation. It will be clear to the skilled person that minor modifications may be made without significant changes to the operation described.

1. A computer-implemented method for estimating a market value of a private company, the method comprising:
retrieving financial data of the private company from a first data source;
providing a machine learning algorithm configured to deliver a valuation coefficient;
retrieving training data for training the machine learning algorithm from a second data source;
training the machine learning algorithm;
computing the valuation coefficient using the trained machine learning algorithm; and
computing a valuation of the private company based on the financial data and the valuation coefficient.

2. The method of claim 1, comprising identifying a plurality of public companies having similar characteristics as the private company; and retrieving data associated with the public companies to obtain the training data.

3. The method of claim 2, wherein identifying the plurality of public companies comprises identifying companies operating in the same industry.

4. The method of claim 2, comprising comparing characteristics of the private company with characteristics of public companies and selecting companies having similar characteristic to the private companies.

5. The method of claim 4, wherein the characteristics comprise risk, growth rate, capital structure, number of employees, cash flow and liquidity data.

6. The method of claim 1, wherein the valuation coefficient is an enterprise multiple.

7. The method of claim 1, wherein the training data include a plurality of data sets, each set comprising input data and output data.

8. The method of claim 1, wherein the machine learning algorithm comprises a set of parameters, and wherein training the machine learning algorithm comprises adjusting the parameters of the machine learning algorithm to reduce an error.

9. The method of claim 1, wherein the machine learning algorithm comprises a neural network algorithm comprising a set of weights and bias.

10. The method of claim 1, wherein training the machine learning algorithm comprises applying at least one of a multi-layer perceptron algorithm and a support vector machine algorithm to the training data.

11. The method of claim 10, comprising using the multiple layer perceptron algorithm to obtain a first error and the support vector machine algorithm to obtain a second error; and comparing the first error with the second error.

12. A system for estimating a market value of a private company, the system comprising:
a processor configured to run a machine learning algorithm for computing a valuation coefficient;
a query system adapted to retrieve financial data of the private company from a first data source; and to retrieve training data for training the machine learning algorithm from a second data source;
a database configured to store the financial data and the training data; and
a memory storing instructions to cause the processor to train the machine learning algorithm using the training data, to compute the valuation coefficient; and to compute a valuation of the private company based on the financial data and the valuation coefficient.

13. The system of claim 12, wherein the query system is adapted to identify a plurality of public companies having similar characteristics as the private company and to retrieve data associated with the public companies to obtain the training data.

14. The system of claim 12, wherein the query system is adapted to group the training data according to a type of companies.

15. The system of claim 12, wherein the processor is adapted to run a plurality of machine learning algorithm, each machine learning algorithm being associated with a particular type of companies.

16. The system of claim 12, wherein the database is configured to store the training data in different groups each group being associated with a type of companies.

17. The system of claim 12, comprising a module adapted to perform textual analysis to retrieve data from a document.

18. The system of claim 12 wherein the query system comprises at least one of
i) a filter configured to filter data stored in the first data source; and
ii) an identifier configured to identify specific data stored in the second data source.

19. The system of claim 12, wherein the database comprises a first storage portion configured to store static data and a second storage portion configured to store dynamic data; and wherein the processor is adapted to retrieve static data and dynamic data using a data link.

20. A computer-readable data carrier having stored thereon instructions which when executed by a computer cause the computer to carry out the method of claim 1.
